(19) United States
(12) Patent Application Publication
(10) Pub. No.: US 2016/0068415 A1
(43) Pub. Date: Mar. 10, 2016

(54) IMPROVED METHOD FOR REMOVING FLUORIDE FROM AQUEOUS STREAMS

(71) Applicant: Chemetics Inc., Vancouver (CA)

(72) Inventors: Felix Man Fai Mok, Vancouver (CA); Stacey Dee, Vancouver (CA); Ian Christopher Bailey, Vancouver (CA)

(21) Appl. No.: 14/651,144

(22) PCT Filed: Dec. 10, 2013
(86) PCT No.: PCT/CA2013/050948

§ 371 Date: Jun. 10, 2015

Related U.S. Application Data
(60) Provisional application No. 61/738,372, filed on Dec. 17, 2012.

(51) Int. Cl. C02F 1/52; C02F 1/44; C02F 1/66

(52) U.S. Cl. CPC C02F 1/5236; C02F 1/66; C02F 1/442; C02F 1/5245; C02F 2101/14

(57) ABSTRACT

Fluoride ions can be removed from an aqueous stream to desirable levels (e.g. less than 1 ppm) using two precipitation reactions in series. In this method, calcium chloride and a phosphate salt are added to form a first precipitate and then a carbonate salt is added to form a second precipitate. However under certain circumstances, the conventional stoichiometries employed have been found to remove insufficient fluoride. Instead, sufficient fluoride can be removed by employing unconventional stoichiometries, specifically excessive calcium chloride or deficient carbonate salt.

### TECHNICAL FIELD

The present invention pertains to methods for removing fluoride ions from aqueous streams. In particular, it pertains to removing substantial fluoride (e.g. to <1 ppm F⁻¹) by modifying the stoichiometries of the reactants involved.

### BACKGROUND

Various aqueous streams are encountered in industry with undesirable levels of contaminants which must be removed either for further processing or for disposal. Fluoride contaminants can be problematic in that in many applications, only very low levels can be tolerated (e.g. of order of ppm or less). For instance, in a sodium chlorate electrolytic system, the presence of fluoride impurities in concentrations greater than 1 ppm would lead to corrosive attack on typical titanium anode structures in the electrolyzer, thus causing passivation of the titanium substrate and subsequent dissolution and loss of electrocatalyst coatings. As a result, high cell voltages along with high oxygen production in the electrolytic system can develop, which in turn can create a dangerous scenario where the gas mixture (e.g. >4% O₂ in H₂) in the system exceeds the explosive limit, thus potentially leading to an explosion.

A conventional approach for fluoride removal in sodium chlorate liquor is by the chemical precipitation route disclosed in U.S. Pat. No. 5,215,632 in which a two-stage precipitation technique is used. A two-stage chemical reaction system is used in which the first stage involves addition of a stoichiometric amount of calcium chloride in about 20 mole % excess. A source of phosphate is also added at about +/−10 mole % per mole of fluoride present in the liquor to be treated in order to promote the formation of calcium sulfate and a compound of calcium fluoride and phosphate. After allowing time for reacting and settling, the mixture is either decanted or filtered. The filtrate is further treated in a second stage where sodium carbonate is added in an amount stoichiometric with the amount of the calcium ions added in the first stage to promote the precipitation of a compound containing both fluoride and calcium. The resultant slurry after settling is further processed via decantation or filtration to produce a solids free sodium chlorate solution with a residual fluoride concentration in the range of 0.1 ppm.

The reasons for the formation of precipitate in the aforementioned technique were not fully understood. However, it and other techniques can be useful in removing fluoride and other contaminants from various industrial aqueous streams (including chlor-alkali or chlorate liquors, hydraulic fracturing fluid, and other ionic solutions or electrolytes which are commonly used in an electrolytic process with an electro-catalytically activated anode structure, typically a dimensionally stable anode of titanium substrate). Still, conventional techniques may not adequately remove fluoride from streams with all the varied compositions encountered in these various applications. The present invention addresses these and other needs as described below.

### SUMMARY

Fluoride ions can be removed from an aqueous stream to desirable levels (e.g. less than 1 ppm) using two precipitation reactions in series. In this method, calcium chloride and a phosphate salt are added to form a first precipitate and then a carbonate salt is added to form a second precipitate. However under certain circumstances (e.g. lower amounts of sulfate, higher amounts of fluoride), the conventional stoichiometries employed have been found to be inadequate to reduce the fluoride impurities to a low level. In particular, experimentation has shown that an excessive amount of carbonate used in the 2^{nd} precipitation stage can adversely affect the fluoride precipitation mechanism. Instead then, sufficient fluoride can be removed by employing unconventional stoichiometries, specifically more calcium chloride and/or less carbonate salt than otherwise would be expected.

In some instances, the present methods can result in a higher level of residual calcium than is preferred. In these instances, an optional third precipitation stage may be used to desirably reduce the calcium remaining. For instance, a three-stage precipitation process has been demonstrated to be effective in treating typical contaminated sodium chlorate liquors and can achieve residual fluoride concentrations of <0.1 ppm and calcium of <10 ppm.

Specifically, the present methods are for removing fluoride ions from an aqueous stream comprising fluoride ions in an amount greater than zero, and sulfate ions in an amount greater than or equal to zero. In a first stage, CaCl₂ and a phosphate salt are added to the stream, thereby forming a first precipitate comprising a chloride salt and a compound comprising calcium, fluoride, and phosphate. If sulfate ions were present, the first precipitate also comprises a sulfate salt. The first precipitate is removed, thereby producing a first stage product stream. In a second stage, a carbonate salt is added to the first stage product stream, thereby forming a second precipitate, and the second precipitate is removed, thereby producing a second stage product stream. The method is characterized in that the amount of CaCl₂ added is greater than (1.2 times the molar concentration of sulfate ions in the aqueous stream plus 5 times the molar concentration of fluoride ions in the aqueous stream), and/or the amount of carbonate salt added is less than 0.9 times the molar concentration of CaCl₂ added. Further, in the first stage, the amount of phosphate salt added can be about 3 times the molar concentration of fluoride ions in the aqueous stream. And it is desirable in the first stage to have the pH of the aqueous stream be less than or about 8.

The methods are suitable for use in aqueous streams comprising greater than 20 ppm fluoride, and particularly including streams with greater than or equal to 150 ppm fluoride. Further, the method is suitable when the streams comprise less than about 10 g/l of sulfate ions.

In the method, certain bases may desirably be adopted for determining the stoichiometries of the additives. For instance, when the amount of sulfate ions in the aqueous stream is less than or about 5 g/l, the amount of CaCl₂ added can be equal to a selected minimum amount. When the amount of sulfate ions in the aqueous stream is greater than or equal to about 5 g/l, the amount of carbonate salt added can be about equal to 1.1 times the molar concentration of calcium ion remaining in the first stage product stream. When the amount of sulfate ions in the aqueous stream is less than about 5 g/l, the amount of carbonate salt added can be from about 0.4 to 0.6 times the molar concentration of calcium ion remaining in the first stage product stream. And it can be desirable that the amount of carbonate salt added results in the second stage product stream comprising from about 2 to 2.8 g/l carbonate salt.

The methods are particularly suitable for aqueous streams comprising a sodium salt (e.g. sodium chloride or brine). And the phosphate salt employed can be trisodium phosphate and the carbonate salt employed can be sodium carbonate.

For example, streams that can be advantageously treated in this way include sodium chlorate liquors (in chlorate electrolysis systems) comprising sodium chlorate, sodium chloride, and sodium dichromate, and chlor-alkali liquors (in chlor-alkali electrolysis systems) comprising a metal chloride such as sodium or potassium chloride. In these instances, fluoride removal can be quite important when the electrolysis involves the use of dimensionally stable anodes with titanium substrates. In addition though, any other industrial process stream contaminated with fluoride impurities may be considered for treatment, including brine solution from a fracking process in which the brine solution comprises a metal chloride. For instance, flowback from fracking processes are aqueous streams which can, depending on the local geology and various other factors, comprise up to 1000 mg/l fluoride ions.

If desired, sulfate ions can be removed from the aqueous stream before adding CaCl₂ and the phosphate salt to the stream in the first stage. This can be accomplished using an upstream sulfate removal system comprising a nanofiltration system.

The optional three-stage precipitation process can additionally comprise, in a third stage, adjusting the pH of the second stage product stream to be greater than about 10, thereby forming CaCO₃ precipitate.

The CaCO₃ precipitate is removed, thereby producing a third stage product stream. The pH adjustment can simply involve adding NaOH to the second stage product stream. Under certain circumstances, it can be advantageous to also add an additional amount of carbonate salt to the second stage product stream.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

Herein, in a numerical context, the term “about” is to be construed as meaning plus or minus 10%.

Throughout this document, quantities expressed in ppm are all made on a weight basis.

It has been discovered that prior art methods for fluoride removal do not always remove a satisfactory amount of fluoride in certain circumstances. For instance, via experimentation according to the method of U.S. Pat. No. 5,215,632, it was observed that an excess of sodium carbonate used in the 2^{nd} precipitation stage to promote the calcium carbonate formation, could adversely affect the fluoride precipitation mechanism. When the amount of sodium carbonate was added in an amount stoichiometric with the amount of calcium ions added in the 1^{st} stage, the fluoride removal reaction, likely promoted by a co-precipitation reaction, could be compromised. Based on additional experimentation, a two stage precipitation process employing unconventional additive stoichiometries proved acceptable, specifically more calcium chloride and/or less carbonate salt than otherwise would be expected. In some instances, this approach can result in a higher level of residual calcium than is preferred (because high residual Ca²⁺ concentration in sodium chlorate liquor can potentially promote scaling on the electrodes of a chlorate electrolyzer). Here, a process employing an optional 3rd precipitation stage was an effective and predictable way to desirably reduce the calcium. This was particularly useful in treating typical contaminated sodium chlorate liquors and can achieve residual fluoride concentrations of <0.1 ppm and calcium of <10 ppm. In addition, when compared with prior art methods, the present invention can use less chemical additives and consequently produce less solids for downstream handling, thus reducing overall operating costs.

As in U.S. Pat. No. 5,215,632, the method is for removing fluoride ions from an aqueous stream comprising fluoride ions and also a variable amount of sulfate ions (from zero and up). In a first stage, CaCl₂ and a phosphate salt are added to the stream, thereby forming a first precipitate comprising a chloride salt and a compound comprising calcium, fluoride, and phosphate. If sulfate ions were present, the first precipitate will also include a sulfate salt. The first precipitate is removed (e.g. via decanting or filtering), thereby producing a first stage product stream. In a second stage, a carbonate salt is added to the first stage product stream, thereby forming a second precipitate, and the second precipitate is removed in a like manner, thereby producing a second stage product stream. However, unconventional stoichiometries are used for the added species. In this improved method, the amount of CaCl₂ added is greater than the expected conventional amount (i.e. 1.2 times the molar concentration of sulfate ions in the aqueous stream plus 5 times the molar concentration of fluoride ions in the aqueous stream), and/or the amount of carbonate salt added is less than the expected conventional amount (i.e. 0.9 times the molar concentration of CaCl₂ added). The amount of phosphate salt added can be the conventional amount (i.e. about 3 times the molar concentration of fluoride ions in the aqueous stream). It is desirable that the pH be less than or about 8 during the first stage because the reaction mechanism in promoting the formation of calcium sulfate and a compound of calcium fluoride and phosphate would be least affected as re-solubilization of the complex precipitates would occur at alkaline pH condition, thus directly releasing the fluoride impurities back into the mixture.

Prior art methods may be unsuitable for removing adequate fluoride in aqueous streams comprising greater amounts of fluoride (e.g. >20 ppm and particularly >150 ppm) and/or comprising lesser amounts of sulfate (e.g. <10 g/l) than were previously reported on. In such streams, the following algorithms may be adopted to obtain appropriate fluoride removal. For instance, when the amount of sulfate ions in the aqueous stream is less than or about 5 g/l, the amount of CaCl₂ added can be set to equal to a selected minimum amount. An appropriate minimum amount may be determined via modest experimentation and basic chemistry principles known to those skilled in the art. Further, when the amount of sulfate ions in the aqueous stream is greater than or equal to about 5 g/l, the amount of carbonate salt added can be set to be about equal to 1.1 times the molar concentration of calcium ion remaining in the first stage product stream. On the other hand, when the amount of sulfate ions in the aqueous stream is less than about 5 g/l, the amount of carbonate salt added can be set to be from about 0.4 to 0.6 times the molar concentration of calcium ion remaining in the first stage product stream.

Another useful alternative algorithm regarding the amount of carbonate salt added is to add sufficient carbonate salt such that the resulting second stage product stream comprises from about 2 to 2.8 g/l carbonate salt. This desirable range should ensure that the equilibrium pH be in the neutral region, 6 to 7, where the competition for the calcium ions between CO₃⁻² and F⁻¹ would be minimized. At pH 7, the predominant species in a HCO₃⁻/CO₃⁻² equilibrium would favour the formation of HCO₃⁻ which has a significantly higher solubility limit when compared to CaF₂ and CaCO₃. In addition, if excessive carbonate salt is added the equilibrium pH would tend to shift to the alkaline region, about pH 10, where disproportionation would favour the CO₃⁻² ions and will directly compete for the calcium ions in solution which would also de-stabilize the CaF₂ reaction mechanism.

While the preceding algorithms are a useful guide, some variation is to be expected in the optimum recipes to follow for any given composition in the aqueous stream being treated. Determining the most appropriate recipe for any such given composition can be accomplished by those of ordinary skill in the art via simple experimental trials.

Exemplary applications for the improved method include removing fluoride from sodium chlorate liquors in chlorate electrolysis plants, chlor-alkali liquors in chlor-alkali electrolysis plants, or from brine solutions resulting in hydraulic fracturing (fracking). The flowback from such fracking processes are aqueous streams, which depending on the local geology and various other factors, can comprise a wide range of fluoride ions from almost none up to 1000 mg/l. Such streams typically comprise metal chlorides such as sodium or potassium chloride and other compounds such as sodium chlorate and sodium dichromate. Although other options may be considered, in such cases it is convenient to use trisodium phosphate as the phosphate salt and sodium carbonate as the carbonate salt.

As mentioned, the amount of sulfate present in the aqueous stream is a consideration in determining what stoichiometries of additives to use. If desired, sulfate ions can be removed independently and upstream of the fluoride removal process (i.e. before adding CaCl₂ and the phosphate salt to the stream in the first stage). Preferred methods for such removal include use of sulfate removal systems employing a nanofiltration system. (Nanofiltration is a preferred, energy efficient, pressure driven membrane separation process.)

As mentioned, use of the improved method can however lead to greater residual calcium levels. If this is not satisfactory, the calcium level can be reduced, for instance, to levels less than 10 ppm using an optional 3^{rd} precipitation stage. In this 3^{rd} stage, the pH of the second stage product stream is adjusted to be greater than about 10 (e.g. via addition of NaOH) in order to promote formation of carbonate ion from bicarbonate ion, thereby forming CaCO₃ precipitate; and then the CaCO₃ precipitate is removed (again via decanting, filtering, or the like), thereby producing a third final stage product stream. If the residual calcium concentration in the secondary filtrate is very high (e.g. >100 ppm), an additional amount of carbonate salt may be added to the second stage product stream.

As illustrated in the following Examples, the prior art method is not always successful in adequately removing fluoride from certain solutions. Without being bound by theory, it is believed in these instances that the sodium carbonate added to the 1^{st} stage filtrate during the 2nd stage of precipitation was too high, causing the equilibrium to shift greatly to favour the formation of calcium carbonate precipitate, thus directly affecting the calcium fluoride precipitation. It is also believed that the formation of calcium fluoride precipitate in the 2nd stage of precipitation is greatly dependent on the formation of calcium carbonate precipitate by way of co-precipitation. Further, the presence of calcium ion appears to be the main driving force in the entire fluoride removal method because without it, elimination of fluoride via the method seems virtually impossible since almost all aspects are affected by or related to the calcium concentration.

The following chemicals reactions are believed to be occurring throughout the method at the indicated pH values:

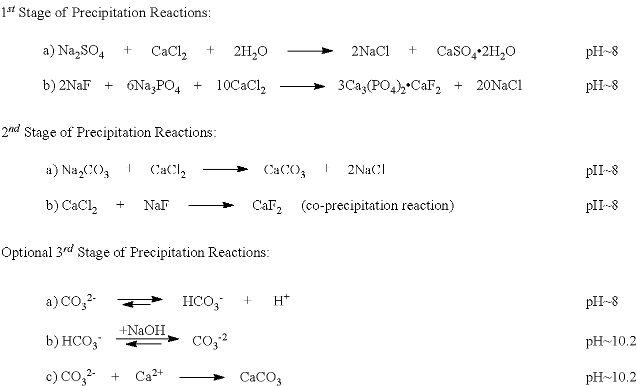

The improved two-stage precipitation method of the invention is effective and suitable to remove fluoride from a wide range of aqueous stream compositions in numerous industrial applications. These applications include both continuous and batch type of applications. In particular, use of the method along with an optional third precipitation stage is effective and predictable for removing fluoride from a diverse range of chlorate liquors. However, as those skilled in the art will appreciate, actual plant liquors and/or streams from other industrial applications may contain impurities which have not been examined in detail yet. Such impurities could possibly impact the fluoride removal method and thus additional refinements to the preferred methods mentioned herein may be necessary.

For instance, it is expected that a brine solution from a fracking process can be successfully treated using a modification of the method of the invention. However, the chemical composition of typical fracking process streams is quite different compared to that of chlorate electrolyte. The alkaline earth metal concentration in the former is usually notably higher. And the various alkaline earth metal cations (Ca, Mg, Ba, Sr) are all expected to react similarly with sulfate, phosphate, and fluoride to form complex precipitate in the first stage reaction. Therefore, the basis for calculating the amount of calcium chloride to add in the 1^{st} precipitation stage should take into account the background alkaline earth metal concentration. Quite often, the actual amount of calcium chloride required to be added can be significantly reduced.

The primary filtrate after removing fluoride impurity contains unreacted alkaline earth metals and can be sent to a salt saturator to increase the NaCl concentration to near saturation before sending to conventional primary treatment which uses caustic and soda ash to promote precipitation of insoluble metal carbonates and metal hydroxides, as well as co-precipitation of other heavy metal impurities. After filtration of such primary treated brine solution, the filtrate can then be sent to secondary treatment where the residual metal impurities are reduced to the ppb range using cationic exchange resins, thereby meeting the feed brine specification for chlor-alkali membrane electrolysis.

In addition, typical brine solution from a fracking process has an intrinsic level of bicarbonate but its buffering capacity is significantly less than that of a typical chlorate electrolyte containing about 5 g/l Na₂Cr₂O₇. As a result, after addition of the basic Na₃PO₄, the pH of the brine solution must be monitored and controlled to a neutral value, preferably less than about 8 to ensure the disproportioning reaction favours the formation of bicarbonate ion and not carbonate ion and thus minimize potential competition for the calcium ions (the main driving force for the reaction) which would otherwise adversely affect the complex precipitation chemistry favourable for fluoride removal. If necessary, addition of HCl solution for pH adjustment may need to be implemented.

At a theoretical pH of 8.1, carbonate species should predominantly exist as the bicarbonate form and the soluble bicarbonate content after the fluoride treatment step will be effectively used during the primary treatment of the filtrate when the pH of the solution is raised to 10 or 11 after addition of caustic and additional soda ash.

The following examples are illustrative of aspects of the invention but should not be construed as limiting in any way.

### Examples

### Experimental Examples

In the following tests, four different representative solution compositions were used which simulated compositions potentially encountered in sodium chlorate liquors.

In all cases, the sodium chlorate liquor solutions comprised 470 g/l NaClO₃, 110 g/l NaCl, and 5 g/l Na₂Cr₂O₇. However, the amounts of sodium sulfate and fluoride ion varied between the solutions tested. Solution type A represented an historic composition exemplified in the aforementioned U.S. Pat. No. 5,215,632. Solution type B represented a solution with substantially more fluoride present than A. Solution type C represented a solution with a lower sulfate content than B and solution type D represented a solution like B but with no sulfate. The actual composition differences are noted in the following Table 1. Note: a separate solution was prepared for each individual test #. In two instances though, namely tests #10 and 11, larger batches of solution were prepared and then split into two, namely tests #10, 10R, 11, and 11R.)

TABLE 1
Compositions of Example Solutions

| Solution type | Na₂SO₄ (g/l) | F⁻¹ (ppm) |
|---|---|---|
| A | 20 | 20 |
| B | 20 | 150 |
| C | 5 | 150 |
| D | 0 | 150 |

Various stoichiometries and approaches were then tried to remove fluoride from each of these four solutions using two precipitation stages, and where indicated an optional third precipitation stage.

### 1^{st} Stage:

In each of the following examples, 400 ml of the indicated solution underwent a first stage precipitation treatment which involved pre-heating the mixture to 30° C., adding the indicated amount of CaCl₂ and immediately thereafter adding the indicated amount of Na₃PO₄. (Note: the actual compounds added were CaCl₂.2H₂O and Na₃PO₄.12H₂O.) The mixture was allowed to react while stirring for 120 minutes. The solids in the slurries formed were then allowed to settle for at least 30 minutes. The samples were then decanted and filtered to separate the solids and filtrate fractions. The residual calcium and fluoride contents in the filtrate (mother liquor) were then measured.

### 2^{nd} Stage:

Then, except where noted, 300 ml of the indicated solution (i.e. the first stage or primary filtrate) underwent a second stage precipitation treatment which again involved pre-heating the mixture to 30° C., adding the indicated amount of Na₂CO₃, and then allowing the mixture to react while stirring for 120 minutes. As before the solids in the slurries formed were then allowed to settle for at least 30 minutes. The samples were then decanted and filtered to separate the solids and filtrate fractions. Here, the final pH along with the residual calcium and fluoride contents in the filtrate were then measured.

### Optional 3^{rd} Stage:

In some instances, solutions were subjected to a third precipitation stage to remove additional residual calcium. The indicated amount of NaOH was added to increase the pH of the secondary filtrate (about 250 ml) to just above 10 in order to convert any bicarbonate present to carbonate. In one instance, additional carbonate salt was also added. Otherwise, the same preheating, stirring, reacting, settling, and filtering procedures were used as described above. And again, the final pH along with the residual calcium and fluoride contents in the filtrate were then measured.

In general, the filter paper used for all three stages had a nominal pore size of 3 μm or lower, which consistently succeeded in producing visibly clear filtrates. The solids formed during the first stage of precipitation were quite coarse and relatively greater in volume, allowing them to settle fairly well over the half hour settling period. A filter paper with good retention for coarse precipitates should thus suffice for the first stage filtration process. The solids formed during the second stage of precipitation were much finer than those formed in the first stage. Thus, it would be important that a filter with good retention for fine crystalline solids be used (e.g. a filter paper with a nominal pore size of 3 μm or less). The same observation was made for the solids formed in the third stage of precipitation.

At the end of testing, a washing study was conducted using the cakes formed during the 1^{st} precipitation stage with deionized water used as rinse water. A weight ratio of 25:1 (grams of deionized water to grams dry cake) was found to be sufficient to displace the entrained mother liquor from the cake so that the washed cake had no visible yellowish (hexavalent chromium) colour.

Tables 2, 3, and 4 summarize the twenty one tests performed including the samples used, the types and amounts of compounds added, and the results obtained for each of the 1^{st}, 2^{nd}, and optional 3^{rd} precipitation stages. Also provided are relevant comparisons (ratios) of the amounts of CaCl₂ and Na₂CO₃ added in the first two precipitation stages [i.e. the ratio of moles of CaCl₂ added to (1.2× moles of sulfate ion in the original solution+5× moles of fluoride ions in the original solution), and the ratio of moles of Na₂CO₃ added to 0.9× moles of CaCl₂ in the original solution respectively]. Additional details and the purpose behind each of the tests are presented after the tables.

TABLE 2
1st precipitation stage

| | | CaCl₂•2H₂O | Na₃PO₄•12H₂O | [Ca⁺²] | [F⁻¹] | |
|---|---|---|---|---|---|---|
| | | added | added | final | final | Ratio* of CaCl₂ |
| Test # | Solution | (g) | (g) | (ppm) | (ppm) | added |
| 1 | A | 9.94 | 0.53 | 1170 | 0.41 | 0.97 |
| 2 | A | 9.94 | 0.53 | 660 | 0.72 | 0.97 |
| 3 | A | 9.94 | 0.53 | 2080 | 0.82 | 0.97 |
| 4 | B | 9.94 | 3.96 | 680 | 0.19 | 0.81 |
| 5 | B | 9.94 | 3.96 | 840 | 1.09 | 0.81 |
| 6 | A | 9.94 | 0.53 | 1880 | 0.14 | 0.97 |
| 7 | B | 9.94 | 3.96 | 750 | 0.19 | 0.81 |
| 8a | C | 2.49 | 3.96 | 0 | 4.97 | 0.52 |
| 8b | C | 2.49 | 3.96 | 16 | 6.11 | 0.52 |
| 9 | C | 4.78 | 3.96 | 1220 | 0.99 | 0.99 |
| 10 | C | 4.78 | 3.96 | 1030 | 0.54 | 0.99 |
| 10R | C | 4.78 | 3.96 | 770 | 0.20 | 0.99 |
| 11 | C | 4.78 | 3.96 | 880 | 0.40 | 0.99 |
| 11R | C | 4.78 | 3.96 | 880 | 0.41 | 0.99 |
| 12 | D | 4.78 | 3.96 | 1270 | 0.70 | 2.06 |
| 13 | D | 4.78 | 3.96 | 1260 | 0.70 | 2.06 |
| 14 | D + 2 g | 4.78 | 3.96 | 940 | 0.79 | 2.06 |
| | Na₂SO₄ | | | | | |
| 15 | D | 4.78 | 3.96 | 1310 | 0.65 | 2.06 |
| 16 | D | 4.78 | 3.96 | 1340 | 0.86 | 2.06 |
| 17 | D | 4.78 | 3.96 | 1420 | 0.97 | 2.06 |
| 18 | D | 4.78 | 3.96 | 1380 | 0.70 | 2.06 |
| 19 | D | 4.78 | 3.96 | 1430 | 1.88 | 2.06 |
| 20 | C | 4.78 | 3.96 | 880 | 0.24 | 0.99 |
| 21 | D | 4.78 | 3.96 | 1420 | 0.76 | 2.06 |

*The “Ratio of CaCl₂ added” here is defined as the ratio of moles of CaCl₂ added to (1.2 × moles of sulfate ion in the original solution + 5 × moles of fluoride ions in the original solution).

TABLE 3
2^{nd} precipitation stage

| | | | | [Ca⁺²] | [F⁻¹] | Ratio*** of |
|---|---|---|---|---|---|---|
| Test | | Na₂CO₃ added | pH | final | final | Na₂CO₃ |
| # | Solution | (g) | (end) | (ppm) | (ppm) | added |
| 1 | A | 7.16 | 10.0 | 0 | 0.77 | 1.11 |
| 2 | A | 7.16 | 10.0 | 0 | 1.12 | 1.11 |
| 3 | A | 1.81 | 6.9 | 500 | 0.00 | 0.28 |
| 4 | B | 0.59 | 7.3 | 385 | 0.00 | 0.09 |
| 5 | B | 0.73 | 7.9 | 190 | 0.00 | 0.11 |
| 6 | A | 1.64 | 7.4 | 318 | 0.00 | 0.25 |
| 7 | B | 0.66 + NaOH | 7.3/11.1* | 0 | 0.00 | 0.10 |
| 8a | C | 0.0187 | 6.8/10.9* | 0 | 4.58 | 0.01 |
| 8b | C | 0.0503 g CaCl₂ + 0.0402 | 6.6 | 0 | 1.28 | 0.02 |
| 9 | C | 1.065 | 7.4 | 270 | 0.08 | 0.34 |
| 10 | C | 0.902 | 7/10.9 | 0 | 0.36 | 0.29 |
| 10R | C | 0.672 | 7.7/11.1* | 18 | 0.00 | 0.22 |
| 11 | C | 0.769 | 7.7 | 76 | 0.00 | 0.25 |
| 11R | C | 0.768 | 8 | 32 | 0.00 | 0.25 |
| 12 | D | 1.11 | 7.8/11.4* | 0 | 0.28 | 0.36 |
| 13 | D | 1.10 | 7.9 | 16 | 0.28 | 0.35 |
| 14 | D + 2 g | 0.821 | 8 | 28 | 0.00 | 0.26 |
| | Na₂SO₄ | | | | | |
| 15 | D | 1.14 | 7.9 | 20 | 0.20 | 0.37 |
| 16 | D | .05 g Na₂SO₄ + 1.17 | 7.9 | 0 | 0.40 | 0.37 |
| 17 | D | .30 g Na₂SO₄ + 1.24 | 8 | 14 | 0.55 | 0.40 |
| 18a** | D | 0.604 | 7.9 | 9 | 0.60 | 0.39 |
| 18b** | D | 0.301 | 7.9 | 610 | 0 | 0.19 |
| 19 | D | 0.625 + 0.625 | 7.9 | 0 | 0.70 | 0.40 (total) |
| 20 | C | 0.769 | 7.9 | 28 | 0.00 | 0.25 |
| 21 | D | 0.620 | 7.2 | 620 | 0.00 | 0.20 |

*In these tests, NaOH was added after carbonate addition to precipitate calcium (see description following); shown therefore are the pH before and after NaOH addition.
**In these tests, the primary filtrate from test # 18 was split into two 150 ml portions.
***The “Ratio of Na₂CO₃ added” here is defined as the ratio of moles of Na₂CO₃ added to 0.9 × moles of CaCl₂ added to the original solution.

TABLE 4
Optional 3^{rd} precipitation stage

| Test | | NaOH added | pH | [Ca⁺²] | [F⁻¹] |
|---|---|---|---|---|---|
| # | Solution | (drops) | (end) | final (ppm) | final (ppm) |
| 5 | B | 10 | 11.6 | 55 | 0 |
| 6 | A | 6.5 | 10.8 | 80 | 0 |
| 9 | C | 7 | 10.8 | 21 | 0 |
| 11 | C | 7 | 11.3 | 0 | 0 |
| 11R | C | 8 | 11 | 10 | 0 |
| 13 | D | 8 | 11.8 | 12 | 0.27 |
| 14 | D + 2 g | 10 | 11.6 | 4 | 0 |
| | Na₂SO₄ | | | | |
| 15 | D | 7 | 11.3 | 20 | 0.17 |
| 20 | C | 8 | 11.1 | 0 | 0 |
| 21 | D | 9 + 0.416 g Na₂CO₃ | 11.4 | 0 | 0 |

Tests #1 and 2 were conducted to validate the fluoride removal technique disclosed in U.S. Pat. No. 5,215,632.

Thus here, the amount of CaCl₂ added was calculated based on the stoichiometric requirement to react away the [SO₄²⁻] in the initial solution plus 20% excess. And the amount of Na₂CO₃ added was based on the stoichiometric requirement to react away the Ca⁺² added during the first stage plus 10% excess. However, less than 0.1 ppm F⁻¹ was not obtained in the secondary filtrate as expected from the teachings of U.S. Pat. No. 5,215,632. It was believed here that the amount of sodium carbonate added to the primary filtrate for the second precipitation stage was too high, causing the equilibrium to shift greatly to favour the formation of calcium carbonate precipitate, and thus directly affecting calcium fluoride precipitation. As discussed, it is also believed that the formation of calcium fluoride precipitate in the second precipitation stage is greatly dependent on the formation of calcium carbonate precipitate by way of co-precipitation. [Oddly, the fluoride concentration in the secondary filtrate in both these tests 1 and 2 was found to be somewhat higher than in the primary filtrate. This could for instance have been due to the voltage reading of the fluoride ion selective electrode (used to measure the fluoride amount) being affected by the excessive amount of carbonate ions in the secondary filtrate or possibly because some calcium fluoride fines may have passed through the filter in the first stage and re-solubilised in the second stage, due to the shift in equilibrium caused by the excessive amount of sodium carbonate added.]

Since the fluoride removal was unsatisfactory in tests #1 and 2, the basis used to calculate the amount of sodium carbonate required in the second precipitation stage was changed. In tests #3 to 7, the amount of Na₂CO₃ added was instead calculated based on the stoichiometric requirement to remove the residual Ca⁺² in the primary filtrate plus 10% excess. The amount of CaCl₂ added was calculated as before in tests #1 and 2. Tests #3 and 6 were performed using solution A, while tests #4, 5 and 7 were performed using solution B with a much higher fluoride concentration. The results from tests #3 to 7 indicate essentially complete fluoride removal from the secondary filtrate, demonstrating that the method of the invention can work successfully on solutions with both the prior art fluoride concentration or much higher fluoride concentrations, provided that the basis for addition of sodium carbonate is appropriately modified.

In chlorate electrolysis applications, high residual Ca²⁺ concentration in the sodium chlorate liquor can potentially promote scaling on the electrodes of the chlorate electrolyser, resulting in higher cell voltage and operating cost. With this application in mind, tests #5 and 6 included the optional 3^{rd} precipitation stage to reduce the calcium level. As shown in Table 4, the calcium levels dropped significantly with this additional stage, but still not to the desired level. This may have been due to insufficient residual carbonate in the secondary filtrate, since most of the carbonate was already consumed to form calcium carbonate precipitate in the 2^{nd} precipitation stage. Test #7 was conducted to simplify the addition steps and here the 2^{nd} and 3^{rd} precipitation stages were combined by adding sodium carbonate and NaOH in the same stage. (Specifically, the sodium carbonate was added first and allowed to react for 15 minutes. NaOH was then added until the pH of the liquor was at least 10. The mixture was allowed to react for another 15 minutes and then to settle for 30 minutes before filtering.) The results of test #7 were superior and demonstrated essentially complete removal of both fluoride and calcium in the secondary filtrate.

Tests 8a and 8b investigated the effect of working with a solution having lower sulfate content (i.e. solution C). In both tests, the amount of CaCl₂ added was calculated based on the stoichiometric requirement to react away the [SO₄⁻²] in the initial solution plus 20% excess (as per U.S. Pat. No. 5,215,632). However, since solution C has only 5 g/l sodium sulfate (¼ that in solution B), the amount of calcium chloride added initially was much less for tests #8a and 8b than in the previous tests. The results in Table 2 show that the fluoride removal efficiency was substantially less in the 1st precipitation stage. To better determine the reaction kinetics, the primary filtrates of tests #8a and 8b were subjected to different conditions in the 2^{nd} precipitation stage. For test #8a, the amount of Na₂CO₃ added was based as before on the stoichiometric requirement to react away the Ca⁺² added during the first stage plus 10% excess. However, for test #8b, additional calcium chloride was added as indicated along with the carbonate. And the amount of Na₂CO₃ added was based here on the stoichiometric requirement to react away the Ca⁺² added during this 2^{nd} stage plus 10% excess. As is evident from Table 3, the 2^{nd} stage fluoride removal efficiency for test #8b was significantly higher compared to that for test #8a, indicating that calcium is likely the main driving force for the fluoride removal mechanism. This then suggests that the relatively poor fluoride removal in the 1^{st} stage of both tests #8a and 8b and particularly in the 2^{nd} stage of test #8a can be attributed to low Ca²⁺ concentration in the solutions.

In subsequent tests #9 to 11R, the same low sulfate solution was treated but using a greater amount of calcium chloride in the 1^{st} precipitation stage. The amount of CaCl₂ added here was calculated based on the stoichiometric requirement to react away the [SO₄⁻²] in the initial solution plus the stoichiometric requirement to react away the PO₄⁻³ added during the 1^{st} stage. The amount of Na₂CO₃ added was again based on the stoichiometric requirement to remove the residual Ca⁺² in the primary filtrate plus 10% excess. Tests #9, 11, and 11R were subjected to a 3^{rd} precipitation stage as described above. Tests #10 and 10R were subjected to the merged 2^{nd} and 3^{rd} precipitation stage process used in test #7 above (except in test #10b, the reaction times were 30 minutes and the mixture was decanted without settling). The results for both tests #11 and 11R showed less than 0.1 ppm fluoride and less than 10 ppm calcium in the final 3^{rd} stage filtrates. Test #9 also showed less than 0.1 ppm fluoride in its 3^{rd} stage filtrate but did not achieve a desirable less than 10 ppm calcium level. Again, this was possibly due to insufficient residual carbonate present in the 2^{nd} stage filtrate since most of the carbonate was already consumed to form calcium carbonate precipitate in the 2^{nd} stage. The results for tests #10 and 10R were not conclusive. (The fluoride remaining in test #10 exceeded the desired less than 0.1 ppm level while essentially no fluoride remained in test #10R.) Based on these results using the low sulfate solution C, including the 3^{rd} precipitation stage appears to be effective in reducing both fluoride and calcium to desirable levels and appears relatively more consistent than the merged 2^{nd} and 3^{rd} precipitation stage.

Tests #12 to 19 investigated fluoride removal efficiency in sodium chlorate liquor with no sulfate content (solution D). Here, the same amount of CaCl₂ was added that was effective when used in tests #9 to 11R for low sulphate solution C. Thus, the amount of CaCl₂ added was equivalent to the stoichiometric requirement to react away 5 g/l sodium sulfate (despite there was actually none present) plus the stoichiometric requirement to react away the associated PO₄⁻³ added during 1^{st} the stage. In tests #12 to 17, the amount of Na₂CO₃ added in the 2^{nd} stage was again based on the stoichiometric requirement to remove the residual Ca⁺² in the primary filtrate plus 10% excess. Note: in test #14, 2 g of sodium sulfate was deliberately added to starting solution D so as to actually introduce 5 g/l sulphate for comparisons sake. The residual Ca⁺² in the primary filtrate of test #14 was lower than that of tests #12 and 13.

Tests #12 and 13 were run to compare results when using either the merged 2^{nd} and 3^{rd} stage precipitation process of test #7 or the optional three-stage precipitation process (tests #12 and 13 employing the former and latter respectively). In neither case however was the desired fluoride level achieved. Test #14 was conducted (in which sulfate was deliberately added to solution D) to determine the role of sulfate in the results. Here, the desired fluoride removal was obtained. Test #15 was run in almost the same manner as test #13. In the latter, a 50 minute settling time had been used in the 1^{st} stage, while the latter used a 30 minute settling time.

Tests #16 and 17 attempted to quantify the effect of sulfate during the 2^{nd} precipitation stage. In both tests, a varied amount (indicated) of sodium sulfate was added to the mixture in the 2^{nd} stage. In neither case was the desired fluoride level achieved. Thus, success in the 2^{nd} precipitation stage did not solely appear to depend on sulphate concentration.

In test #18 then, the amount of carbonate added in the 2^{nd} stage was varied. After the 1^{st} precipitation stage, the filtrate was split into two 150 ml portions to perform two tests side by side, namely test #18a and 18b. Carbonate was added to #18a using the same basis as tests 12-17. However, half the amount of carbonate was added to #18b. The test results clearly confirmed that the desired fluoride removal (<0.1 ppm) could be achieved by reducing the amount of sodium carbonate added in test 18b, while test 18a, which used an amount of sodium carbonate equivalent to the residual calcium, did not successfully attain the desired fluoride removal.

Test #19 was carried out with the same intent as test #7 which was to avoid a 3^{rd} precipitation stage if possible. Since only half of the required stoichiometric amount of carbonate was added now, the residual calcium in the 2^{nd} stage filtrate was much higher. In test #19, an attempt was made to bring down both the fluoride and calcium levels at the same time. In the 2^{nd} stage here then, a reduced (again by half) stoichiometric amount of carbonate was added first and then, after a half hour reaction period, the second half of the required carbonate was added. This resulted in a 2^{nd} stage filtrate with less than 10 ppm calcium and an unsatisfactory 0.6 ppm fluoride. Perhaps by adding the second batch of carbonate in the same reactor as that of the first, the equilibrium may have shifted thus causing the calcium ions to react more favourably with the carbonate, and not the fluoride. Regardless, to ensure consistency and predictability, the optional three precipitation stage process seemed a better option.

Tests #20 and 21 were thus carried out using low sulfate solutions C and D respectively to validate the addition strategies of the invention in combination with the optional third precipitation stage. In test #21, a negligible amount of carbonate remained in the 2^{nd} stage filtrate due to the reduced amount of carbonate added in the 2^{nd} stage. Therefore, in order to effectively remove the calcium to less than 10 ppm in the third stage, more carbonate was added as indicated. (The amount of carbonate added here was calculated based on the stoichiometric requirement to remove the residual calcium in the 2^{nd} stage filtrate plus 10% excess.) Also, to maximize the carbonate ions present in the 3rd stage, the pH was also adjusted to be at least 10. Both tests #20 and 21 yielded the desired <0.1 ppm fluoride and <10 ppm calcium levels in their 3^{rd} stage filtrates.

### Predicted Examples

It is expected that a sodium chlorate liquor solution with even higher fluoride levels can be successfully treated in a like manner. For instance, a sodium chlorate liquor comprising 470 g/l NaClO₃, 110 g/l NaCl, 5 g/l Na₂Cr₂O₇, 0 g/l Na₂SO₄, and 200 ppm F⁻¹ (that is, similar to solution type D except with substantially more fluoride) can be treated using the same three-stage precipitation process and test conditions as were used in test #21 above. It is expected that less than 0.1 ppm fluoride and less than 10 ppm calcium can also be obtained. Tables 6, 7, and 8 show the proposed types and amounts of compounds to add, and the predicted results for each of the 1^{st}, 2^{nd}, and optional 3^{rd} precipitation stages.

It is also expected that a brine solution with high fluoride content from a fracking process can be successfully treated using a modification of the method of the invention. Because the chemical composition of typical fracking process streams is quite different compared to that of chlorate electrolyte, consideration must be given to the background alkaline earth metal concentration for the 1^{st} precipitation stage and to the solution pH after addition of Na₃PO₄. For instance, the composition of a representative fracking process stream appears in Table 5.

TABLE 5
Composition of representative fracking process stream with
high fluoride content and pH 6.2

| Compound | Concentration | |
|---|---|---|
| NaCl | 120 | g/l |
| SO₄⁻² | 0.2 | g/l |
| Ca⁺² | 5.2 | g/l |
| Ba⁺² | 0.66 | g/l |
| Sr⁺² | 0.81 | g/l |
| Mg⁺² | 0.6 | g/l |
| HCO₃⁻ | 0.6 | g/l |
| F⁻¹ | 600 | ppm |

The representative fracking process stream can then be treated using a similar three-stage precipitation process and test conditions as above, but modified amounts of additives. As in the preceding tests, an amount of calcium chloride and trisodium phosphate is added in the 1^{st} precipitation stage. As before, the amount of trisodium phosphate to be added is determined on the basis of fluoride content in the fracking process stream. Also, the amount of calcium chloride required is determined as before. However, here the Ca, Ba, Mg, and Sr ions in the original fracking process stream can contribute to the 1^{st} precipitation stage reactions in much the same manner as does added calcium chloride. Thus, these existing impurities effectively already serve as added calcium chloride to some extent, and so less calcium chloride is actually added. Because the chemistry is complex however, the Ba, Mg and Sr ions may not be fully equivalent to Ca ions. Thus, the amount of calcium chloride added is initially selected on the assumption that all these ions function equivalently to Ca. However, some additional calcium chloride may ideally need to be added in case not all the Ba, Mg, and Sr functions completely equivalently to Ca.

As in the preceding tests, an amount of sodium carbonate is added in the 2^{nd} precipitation stage and is based on the residual calcium (predicted or determined experimentally) in the primary filtrate. Tables 6, 7, and 8 also show the proposed types and amounts of compounds to add for this fracking process stream example, along with the predicted results for each of the 1^{st}, 2^{nd}, and optional 3^{rd} precipitation stages.

TABLE 6
1st precipitation stage for predicted examples

| | CaCl₂•2H₂O | Na₃PO₄•12H₂O | [Ca⁺²] | [F⁻¹] |
|---|---|---|---|---|
| | added | added | final | final |
| Solution | (g) | (g) | (ppm) | (ppm) |
| Sodium chlorate | 5.55 | 5.28 | 1200* | 0.70* |
| liquor with | | | | |
| 200 ppm F⁻¹ | | | | |
| Fracking process | 0** | 14.41 | 1150* | 0.80* |
| stream | | | | |

*Predicted
**The calculated amount to add is actually negative based on total alkaline earth content in original stream

TABLE 7
2^{nd} precipitation stage for predicted examples

| | Na₂CO₃ added | pH | [Ca⁺²] final | [F⁻¹] |
|---|---|---|---|---|
| Solution | (g) | (end) | (ppm) | final (ppm) |
| Sodium chlorate | 0.524 | 7.4* | 600* | 0.0* |
| liquor with 200 ppm | | | | |
| F⁻¹ | | | | |
| Fracking process | 0.502** | 6.8* | 640* | 0.0* |
| stream | | | | |

*Predicted
**Based on predicted residual Ca ion in the primary filtrate

TABLE 8
Optional 3^{rd} precipitation stage for predicted examples

| | NaOH | Na₂CO₃ | | [Ca⁺²] | [F⁻¹] |
|---|---|---|---|---|---|
| | added | added | pH | final | final |
| Solution | (g) | (g) | (end) | (ppm) | (ppm) |
| Sodium chlorate liquor | 0.1 | 0.436 | 11.2* | 5* | 0* |
| with 200 ppm F⁻¹ | | | | | |
| Fracking process stream | 0.1 | 0.465 | 11.1* | 2* | 0* |

*Predicted

These Examples show that the fluoride removal technique taught in U.S. Pat. No. 5,215,632 can be unsatisfactory under certain circumstances, and may not achieve final fluoride concentrations of <0.1 ppm along with desirable calcium levels.

However, by appropriately adjusting the amounts of CaCl₂ and carbonate salt added in the two precipitation stages, less than 0.1 ppm fluoride and desirable calcium levels can be attained. Further, use of an optional 3^{rd} precipitation stage can be employed to achieve very low Ca levels (e.g. <10 ppm).

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, use of the invention for the treatment of industrial effluents and other process streams can also be considered. Such modifications are to be considered within the purview and scope of the claims appended hereto.

1. A method for removing fluoride ions from an aqueous stream comprising fluoride ions in an amount greater than zero, and sulfate ions in an amount greater than or equal to zero, the method comprising:
in a first stage, adding CaCl₂ and a phosphate salt to the stream, thereby forming a first precipitate comprising a chloride salt and a compound comprising calcium, fluoride, and phosphate;
removing the first precipitate, thereby producing a first stage product stream;
in a second stage, adding a carbonate salt to the first stage product stream, thereby forming a second precipitate; and
removing the second precipitate, thereby producing a second stage product stream;
characterized in that:
the amount of CaCl₂ added is greater than (1.2 times the molar concentration of sulfate ions in the aqueous stream plus 5 times the molar concentration of fluoride ions in the aqueous stream); or
the amount of carbonate salt added is less than 0.9 times the molar concentration of CaCl₂ added.

2. The method of claim 1 wherein the amount of CaCl₂ added is greater than (1.2 times the molar concentration of sulfate ions in the aqueous stream plus 5 times the molar concentration of fluoride ions in the aqueous stream).

3. The method of claim 1 wherein the amount of carbonate salt added is less than 0.9 times the molar concentration of CaCl₂ added.

4. The method of claim 1 wherein the amount of phosphate salt added is about 3 times the molar concentration of fluoride ions in the aqueous stream.

5. The method of claim 1 wherein the aqueous stream comprises greater than 20 ppm fluoride.

6. The method of claim 5 wherein the aqueous stream comprises greater than or equal to 150 ppm fluoride.

7. The method of claim 2 wherein the amount of sulfate ions in the aqueous stream is less than about 10 g/l.

8. The method of claim 7 wherein the amount of sulfate ions in the aqueous stream is less than or about 5 g/l, and the amount of CaCl₂ added is equal to a selected minimum amount.

9. The method of claim 3 wherein the amount of sulfate ions in the aqueous stream is greater than or equal to about 5 g/l, and the amount of carbonate salt added is about equal to 1.1 times the molar concentration of calcium ion remaining in the first stage product stream.

10. The method of claim 3 wherein the amount of sulfate ions in the aqueous stream is less than about 5 g/l, and the amount of carbonate salt added is from about 0.4 to 0.6 times the molar concentration of calcium ion remaining in the first stage product stream.

11. The method of claim 5 wherein the amount of carbonate salt added results in the second stage product stream comprising from about 2 to 2.8 g/l carbonate salt.

12. The method of claim 1 wherein the aqueous stream comprises a sodium salt.

13. The method of claim 1 wherein the phosphate salt is trisodium phosphate.

14. The method of claim 1 wherein the carbonate salt is sodium carbonate.

15. The method of claim 1 wherein the pH of the aqueous stream during the first stage is less than or about 8.

16. The method of claim 1 comprising removing sulfate ions from the aqueous stream before adding CaCl₂ and the phosphate salt to the stream in the first stage.

17. The method of claim 16 wherein the sulfate ion removing comprises using a nanofiltration system.

18. The method of claim 1 wherein the aqueous stream is sodium chlorate liquor comprising sodium chlorate, sodium chloride, and sodium dichromate.

19. The method of claim 1 wherein the aqueous stream is chlor-alkali liquor comprising a metal chloride.

20. The method of claim 1 wherein the aqueous stream is a brine solution from a fracking process and the brine solution comprises a metal chloride.

21. The method of claim 1 additionally comprising:
in a third stage, adjusting the pH of the second stage product stream to be greater than about 10, thereby forming CaCO₃ precipitate; and
removing the CaCO₃ precipitate, thereby producing a third stage product stream.

22. The method of claim 21 wherein the adjusting comprises adding NaOH to the second stage product stream.

23. The method of claim 21 comprising adding an additional amount of carbonate salt to the second stage product stream.
